(19) United States
(12) Patent Application Publication
(10) Pub. No.: US 2024/0311344 A1
(43) Pub. Date: Sep. 19, 2024

(54) COPY SUBSYSTEM FOR MULTIPLE LEVEL FILE TRANSFER IMPLEMENTED ON THINGWORX PLATFORM

(71) Applicant: AMO Development, LLC, Irvine, CA (US)

(72) Inventors: Aaron Coleman, Milpitas, CA (US); Marcellus Young, Milpitas, CA (US); Jon Johnson, Milpitas, CA (US); Larry Mattison, Milpitas, CA (US)

(21) Appl. No.: 18/183,939

(22) Filed: Mar. 14, 2023

(51) Int. Cl. G06F 16/182

(52) U.S. Cl. CPC G06F 16/1844; G06F 16/1827

(57) ABSTRACT

In a cloud system that includes a cloud server and multiple edge devices implementing the ThingWorx platform, an improved file transfer method for transferring multiple files from the edge device to a file repository of the cloud server. The method provides multi-level path traversal and copy from a specified root level, in a file system containing a plurality of nested variably named paths, with the abilities to exclude path(s) in the path traversal and copy, to specify custom date(s) in the past as the earliest date to transfer file(s), to specify and track copy retries, and to track and report file copy metrics.

### BACKGROUND OF THE INVENTION

This invention relates to file management in a cloud environment, and in particular, it relates to file copy functions in a system including Internet of Things (IoT) edge devices connected to a cloud using the ThingWorx platform.

The Internet of Things (IoT) is a system that allows physical objects or devices equipped with sensors to communicate over the Internet with each other and with other data processing systems, so as to facilitate exchange of data and management of such physical objects or devices. IoT technologies are widely adopted in consumer, commercial, industrial and many other spaces.

ThingWorx is an industrial IoT (IIoT) software platform. “ThingWorx is a rapid, model-based application development platform. By employing modeling instead of coding, the content developer is able to focus on agility and application composition rather than debugging, maintaining, and updating code. The model artifacts become a set of reusable building blocks to assemble new applications. After you have your model in place, you can assemble the data, services, and capabilities of the model into a Web application via the drag-and-drop Mashup Builder.” (See https://support.ptc.com/help/thingworx_hc/thingworx_8_hc/en/index.html#page/ThingWorx/Help/Getting_Started/GettingStarted.html#)

### SUMMARY OF THE INVENTION

The present invention is directed to methods and related apparatus that improve the capabilities of IoT systems that are based on the ThingWorx platform.

An object of the present invention is to provide enhanced file transfer capabilities for an IoT system that is based on the ThingWorx platform.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a file transfer method in a cloud system that includes a cloud server and at least one edge device implementing ThingWorx, the cloud server having a file repository, the edge device having a file system containing a plurality of nested variably named paths, the method including: (a) receiving a file transfer request, the request specifying a transfer process name and a root path in the file system of the edge device that contains files to be transferred; (b) iterating through all paths under the root path, identifying a plurality of child paths under the root path; (c) identifying files to be transferred in all identified paths, based on a date range; (d) transferring all files identified in step (c) from the edge device to the repository of the cloud server; and (e) for any file transferred in step (d) that failed, storing path and file information of the file as an entry in a persistent failed file transfer infotable on the cloud server, the failed file transfer infotable being associated with the transfer process name.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF DRAWINGS

FIG. 1 schematically illustrates an IoT system including multiple edge devices communicating with a cloud according to embodiments of the present invention.

FIG. 2 schematically illustrates a file folder system on an edge device.

FIGS. 3-7 are flowcharts that schematically illustrates a ThingWorx copy subsystem according to embodiments of the present invention.

### DETAILED DESCRIPTION OF THE INVENTION

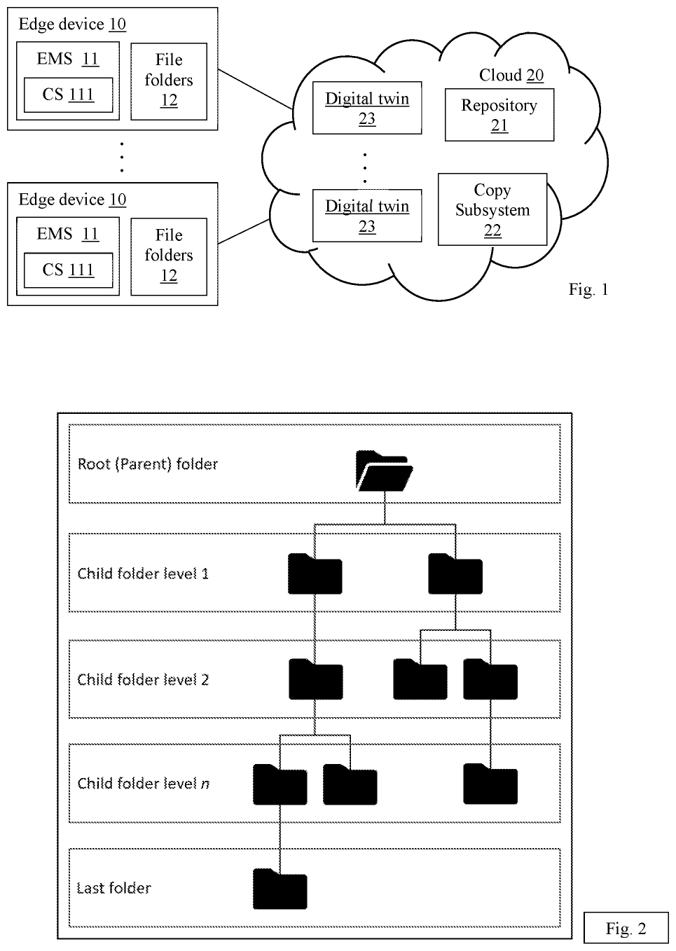

FIG. 1 schematically illustrates an IoT system that includes multiple edge devices 10 communicating with a cloud 20. The cloud includes 20 a set of servers and services, for example, a set of servers and services within a virtual private cloud (VPC). Each edge device 10 is a device, such as a medical device, that includes a processor having installed on it a software component Edge MicroServer (EMS) 11. The edge device stores a file system 12 that may include multi-level nested file folders with files stored therein. The cloud 20 maintains a persistent file storage location (repository) 21 within it. The cloud also maintains multiple cloud resident entities, referred to as digital twins 23, each of which being a representation of an edge device. In preferred embodiments of the present invention, the EMS and the servers of the cloud both implement the ThingWorx platform. The edge device 10 also runs a suitable operating system (not shown in FIG. 1).

The file system 12 stored on the edge device may include nested variably named folders and files residing within a root folder, an example of which is schematically illustrated in FIG. 2.

The following ThingWorx concepts are used in this disclosure:

Things: Things are representations of physical devices, assets, products, systems, people, or processes that have properties and business logic. All Things are based on Thing Templates (inheritance) and can implement one or more Thing Shapes (composition). (See https://support.ptc.com/help/thingworx_hc/thingworx_8_hc/en/index.html#page/ThingWorx/Help/Composer/Things/Things.html#wwID0EMFOV)

Thing Properties: Thing properties are used to describe the data points that are related to a Thing. Each property has a name, description, and a ThingWorx data type, known as a base type in ThingWorx. Depending on the base type, additional fields may be enabled. (See https://support.ptc.com/help/thingworx/platform/r9/en/index.html#page/ThingWorx/Help/Composer/Things/ThingProperties/ThingProperties.html)

Infotable: An infotable is a zero-indexed, ordered array of objects that expose the same properties. (See https://support.ptc.com/help/thingworx_hc/thingworx_8_hc/en/index.html#page/ThingWorx/Help/Composer/Infotables.html)

Streams: Streams represent time series data. Therefore, each stream has a timestamp and additional fields. A ThingWorx stream is a list of activities from things or data associated with Things. A stream can be thought of as a table structure with fields. (See https://support.ptc.com/help/thingworx_hc/thingworx_8_hc/en/index.html#page/ThingWorx/Help/Composer/DataStorage/Streams.html)

Subsystems: Subsystems are system integration tools that provide functionality that can be configured according to execution requirements. Subsystems handle event processing, file transfer, federated data storage, Web socket communications, stream processing, tunneling processing, and configuration. (See https://support.ptc.com/help/thingworx_hc/thingworx_8_hc/en/index.html#page/ThingWorx/Help/Composer/DataStorage/Streams.html)

File Transfer Subsystem: The file transfer subsystem provides the required methods to manage file transfers between Remote Things, file repositories, and federated servers. (See https://support.ptc.com/help/thingworx_hc/thingworx_8_hc/en/index.html#page/ThingWorx/Help/Composer/System/Subsystems/FileTransferSubsystem.html#)

Note that in this disclosure, “transfer” and “copy” are used interchangeably, and “folder” and “path” are used interchangeably.

Currently, using ThingWorx, each path copy process is run as an individual service. There are no multiple path services; copying multiple paths would require multiple services. Further, there are currently few statistics that can be gathered regarding transfer process metrics. Moreover, there are no user-defined retry specifications. Each copy process has substantial inputs required, which make the process cumbersome and inefficient.

More specifically, the current IoT edge device copy subsystem using ThingWorx does not address the ability to perform the following requirements/functionality: The ability to, from a specified root level, perform multi-level path traversal and copy; the ability to, in a multi-level path traversal and copy, exclude path(s); the ability to specify custom date(s) in the past as the earliest date to transfer file(s); the ability to, with randomly created path names and file names, copy files from paths; the ability to specify and track copy retries; and the ability to track and report file copy metrics.

Embodiments of the present invention provides a ThingWorx copy subsystem with enhanced functionalities that addresses the above shortcomings of the current ThingWorx file transfer subsystems. The copy subsystem includes a software component 22 running on the cloud 20, and optionally a software component 111 running on the edge device 10, as schematically illustrated in FIG. 1.

In an exemplary embodiment, the copy subsystem requires the user-issued file transfer request to include certain input information for the copy process, such as (* denotes required inputs):

Copy process name*;

Root path*: the highest level folder on the edge device that contains the files to be copied (It should be noted that the Root path may not be the root path of the entire file system on the edge device);

Static path: a flag that indicates a single path copy job (True) or a multi-level copy job (False);

Historical days to reference;

Maximum copy retry count;

Path exclusions: a table listing paths under the Root path that are to be excluded from the file transfer;

File name mask: use to select and transfer only files that match the specified name mask; and

Ad-hoc copy: a True/False flag that indicates whether it is an ad-hoc copy job.

With these user-specified inputs, logic within the copy subsystem handles all needed details to accomplish single-path or multi-path copy jobs. This includes the ability to create properties and tables to track copy failures, retries, and multiple informational data points.

Among the advantages of the copy subsystem are its ease of use, the ability to iterate multi-level nested directories (folders) with non-standard naming conventions, and copy files from each level. The copy subsystem also has the ability to specify paths so that they can be excluded from the copy process, as well as view job metrics post copy.

In a practical example, prior to the first run of a copy job using the copy subsystem, an authenticated user with appropriate permissions configures inputs for the copy process. This configuration can either be persistent or be run from a child service. This process can also be run either automated or initiated via user interaction. It can be run ephemerally, or directly from a user interface. Only an ad-hoc copy run can be configured ephemerally.

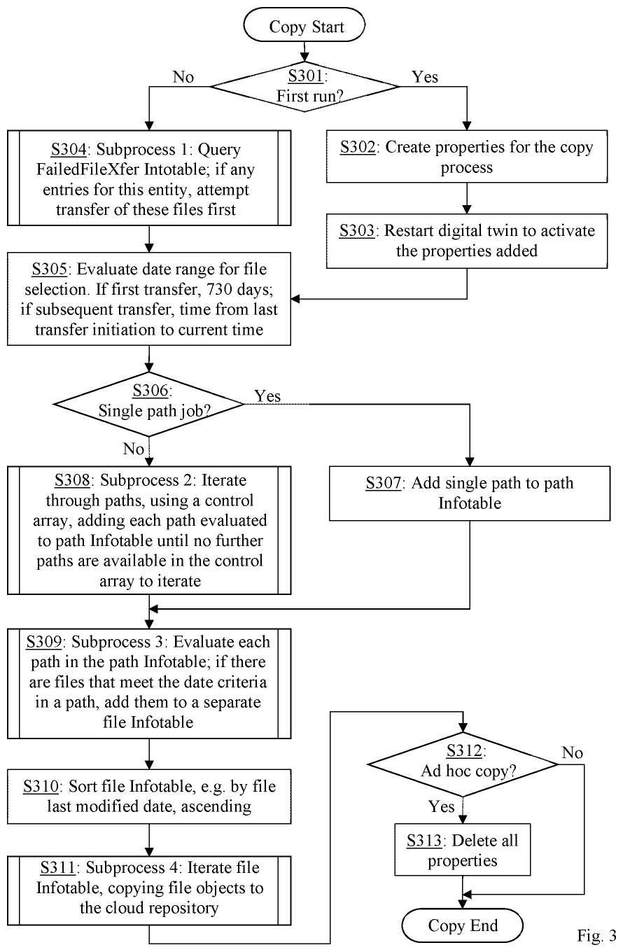

The copy subsystem is described below with reference to FIGS. 3-7. Referring to FIG. 3 (main process flow), the copy subsystem first evaluates whether required tracking and telemetry properties exist for the specified copy process name (step S301). If they do not (i.e., it is a first run of the named copy process, Yes in step S301), the properties are programmatically created based upon the copy process name (step S302). The properties include, for example (all properties may be prefixed with the copy process name):

FailedFileXfer, an Infotable containing information of previously failed file transfer, including path, file name, and datetime of most recent copy attempt.

FileCount, a count of the total umber of files to be transferred in the copy process;

InitialXfer, a Boolean property that is changed from false to true upon the completion of the initial file transfer;

IntermediateXfer, a datetime property that is populated with the last modified datetime property of the file that was most recently successfully transferred from the edge device to the cloud.

MaxCopyRetries, a number that sets the maximum number of times that a failed file transfer will be retried;

MBCount, a property representing the transfer size;

MostRecentXferDate, a property representing the date that the named copy process was most recently run;

PathCount, a count of the total number of paths containing files to be transferred in the copy process; and

TotalRunTime, a property representing the total tun time of the copy process.

The digital twin for the edge server is restarted to activate the properties that has just been created (step S303).

If, on the other hand, the copy process is not a first run of the named copy process (No in step S301), a first subprocess (Subprocess 1) is executed, which queries the FailedFileXfer Infotable for this copy process, and if there are any entries listed therein, the copy subsystem attempts to transfer these files first (step S304, described in more detail later).

After step S303 or step S304, the copy subsystem then evaluates the date range of the file selection, for example, based upon the Historical days to reference input (step S305). Alternatively, if it is a first transfer of the named copy process, the date range may be defaulted to 730 days (two years). Or, if it is a subsequent run of the named copy process, the date range may be set to be the difference between the date of the last successful file copied and the current date.

The copy subsystem then determines whether or not the copy process is a single path copy job by evaluating the Static Path flag (step S306). If it is (Yes in step S306), the single path (the Root Path) is added to a path Infotable (step S307). If it is not (No in step S306), a second subprocess (Subprocess 2) is executed (step S308), which iterates through all folders and sub-folders (paths) of the file system under the Root Path, using a control array, beginning with the Root Path and ending with the last available folder, and adds each path evaluated to the path Infotable (unless the path matches an entry in the Path Exclusions table), until no further paths are available in the control array to iterate.

The control array is an internal array used for intermediate tracking of paths. It is not listed as a tracked property since it is only used programmatically within the code structure.

More specifically, in Subprocess 2 (FIG. 5), the copy subsystem iteratively evaluates path(s) in the control array to see if there are child paths (step S501). Any path in the control array that matches an entry in the Path Exclusions table is skipped (Yes in step S502). If the current path is not in the Path Exclusions table (No in step S502) and child path(s) exist for it (Yes in step S503), the child path is added to the control array, and the current path is added to the path Infotable and removed from the control array (step S504), and the system continues to iterate the path(s) in the control array (step S501). If no child path exists for the current path (No in step S503), the current path is added to the path Infotable and removed from the control array (step S505). The copy subsystem continues to iterate the path(s) in the control array (step S501), and ends after it has reached the last path in the control array (Yes in step S506).

Referring back to FIG. 3, after step S308 or step S307, the copy subsystem executes a third subprocess (Subprocess 3), which evaluates each path in the path Infotable and determine if there are any files within the path; if there are files that are within the specified date range in a path, they are added to a separate file Infotable (step S309).

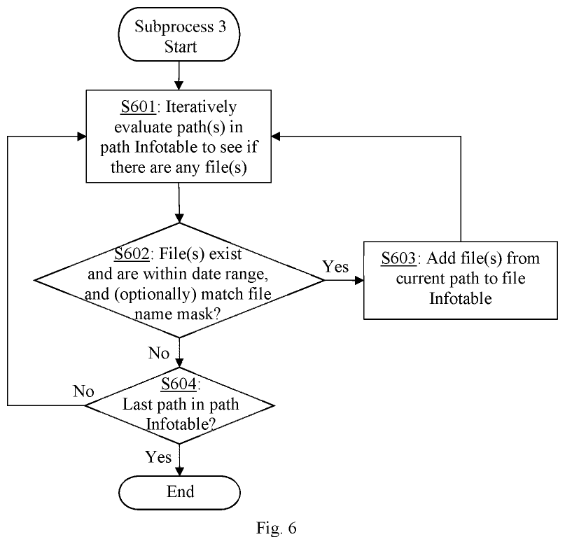

More specifically, in Subprocess 3 (FIG. 6), the copy subsystem iteratively evaluate path(s) in the path Infotable to see if there are file(s) in each path (step S601). If any file(s) exist and are within the specified date range (Yes in step S602), these file(s) are added to the file Infotable (step S603). Thereafter, the system continues to iterate the paths in the path Infotable (step S601). The copy subsystem continues to iterate the path(s) in the path Infotable, and ends after it has reached the last path in the path Infotable (Yes in step S604).

Referring back to FIG. 3, after completing Subprocess 3, the copy subsystem sorts the file Infotable (step S310). For example, the sort may be by the file last modified date in an ascending order, i.e., from the oldest file modified date to the most recent modified date. Then, the copy subsystem executes a fourth subprocess (Subprocess 4), which iterates the file Infotable, copying file objects listed in the file Infotable to the cloud repository (step S311). In this subprocess, once a file transfer is complete, it will reflect successful and validated or it will reflect an error state. Regardless of the status of transfer, the statistics may be logged to a master file transfer table, which is a stream used to track all transfers of the copy process. Salient information is also logged to be added to the overall file transfer job telemetry properties. If a file transfer reflects any status other than verified, it will be considered a failed copy. In such a case the path name, file name, and date added are entered into the persistent Failed File Transfer Infotable (FailedFileXfer) in the Digital Twin.

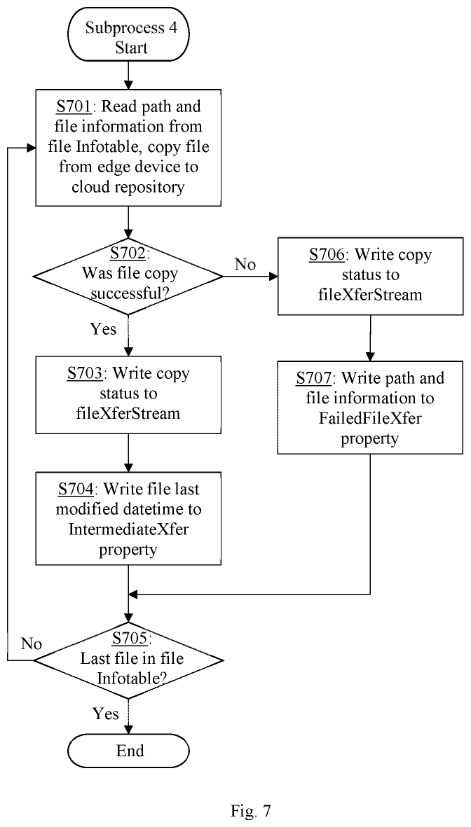

More specifically, in Subprocess 4 (FIG. 7), the copy subsystem iteratively reads path and file information from the file Infotable, and copy the next file from the edge device to the cloud repository (step S701). If the file is successfully copied (Yes in step S702), the copy status is written to a file transfer stream (fileXferStream) (step S703), and the file last modified date and time are written to an intermediate transfer property (IntermediateXfer) (step S704). The intermediate transfer property is updated every time a file is successfully copied, and may be used in case a subsequent file copy fails (this, this property can serve as a timestamp placeholder). If the file was the last file in the file Infotable (Yes in step S705), the subprocess ends. Otherwise (No in step S705), the subprocess returns to read the next path and file information (step S701). If, on the other hand, the file copy is not successful (No in step S702), the copy status is written to the file transfer stream (fileXferStream) (step S706), the path and file information is written as an entry in the Failed File Transfer table (FailedFileXfer) (step S707), and the subprocess goes to step S705.

Referring back to FIG. 3, subprocess 4 completes the file transfer. At this time, if the copy process is an ad hoc copy process (Yes in step S312), all properties of the copy process created in the Digital Twin are deleted (step S313). The copy subsystem exits.

Thereafter, when the edge device is reconnected to the cloud, a persistent copy process is triggered. Upon starting the copy process, the copy subsystem queries the Failed File Transfer table (step S301), and if the tracking and telemetry properties exist (No in step S301, i.e., not first run), Subprocess 1 is performed to attempt to transfer previously failed files. If the transfer of the previously failed file completes, with a validated status, its statistics are entered into the master file transfer table.

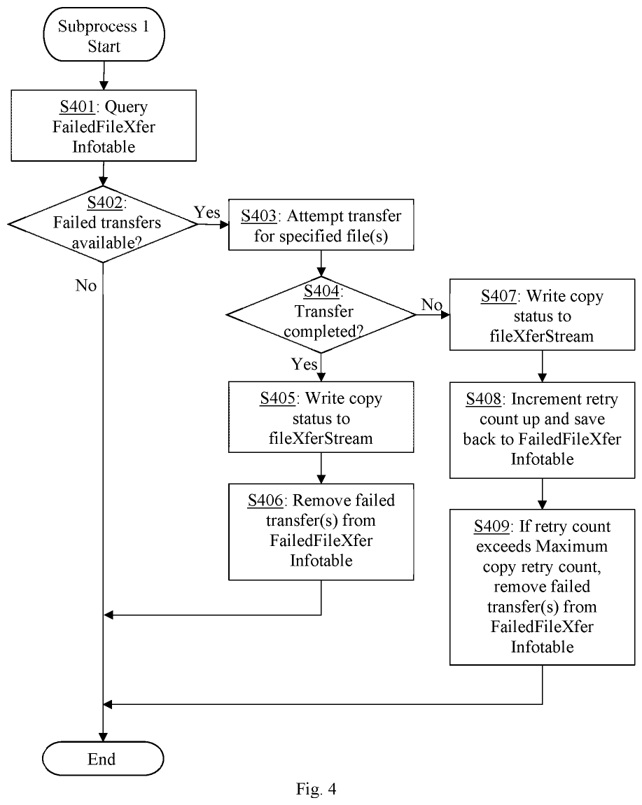

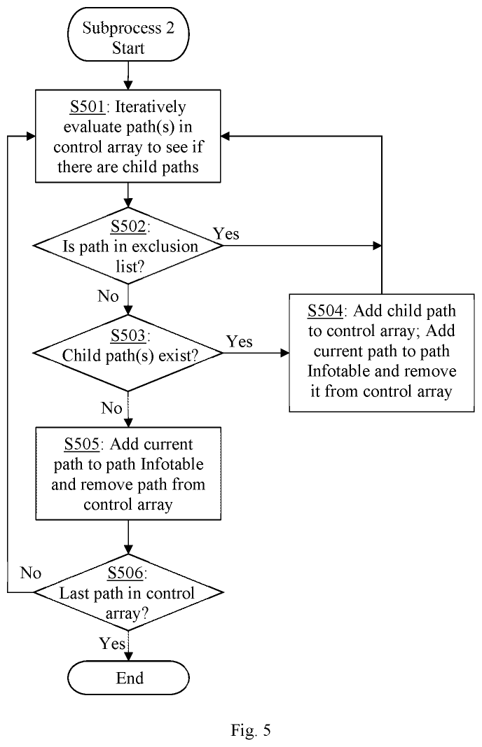

More specifically, in Subprocess 1 (FIG. 4), the copy subsystem queries the Failed File Transfer Infotable (FailedFileXfer) (step S401). If failed transfer entries are present in the table (Yes in step S402), the copy subsystem attempts transfer for the file(s) specified in the table (step S403). If the transfer is complete (Yes in step S404), the copy status (complete) is written to the file transfer stream (fileXferStream) (step S405), and the failed transfer entries are removed from the Failed File Transfer Infotable (FailedFileXfer) (step S406). If, on the other hand, the status is anything other than validated (No in step S404), the copy status (incomplete) is written to fileXferStream (step S407), and the entry in the Failed File Transfer Infotable (FailedFileXfer) is updated, e.g., the date Attempted field is updated with a date attempted, and the retry count is incremented up by 1 (step S408). If the retry count exceeds the maximum copy retry count, the entry is removed from the Failed File Transfer Infotable (FailedFileXfer) (step S409).

Referring back to FIG. 3, after processing entries in the Failed File Transfer table (step S304), the copy subsystem queries a property that contains the modified date of the last successful file copied (for example, the intermediate transfer property (IntermediateXfer)), and sets the date range for new files to be transferred based on the difference between that date and the current date (step S305).

During the copy subsystem execution, various other tracking and telemetry properties are logged, for example: Total run time is logged to the Total Run Time property (TotalRunTime). Path count is logged to the Path Count property (PathCount). File count is logged to the File Count property (FileCount). Most recent transfer date is logged to the Most Recent Xfer Date property (MostRecentXferDate). Transfer size is logged to the MB Count property in megabytes (MBCount).

For any new copy attempts that are not successful in one run, the process for failed transfer(s) will repeat in the next run.

The process described above encompasses treatment for a single path copy job, although in Subprocess 3, the path Infotable will contain only a single path to be iterated, and therefore only files from that specified path are transferred.

For an ad-hoc copy job, i.e., with the Ad-hoc copy input set to True, the copy job will proceed normally as described above, but all properties created during the copy run are deleted after copy completion (steps S312, S313 in FIG. 3). Thus, failed copy retries will not be performed for an ad-hoc copy job.

The copy subsystem may be modified to allow selecting and copying only files that match a specified name mask. More specifically, if there is a specified pattern in the File Name Mask input, then only files that match the given pattern will be selected and copied. For example, if a string of ‘*txt’ is entered into the File Name Mask input, only files with the extension of ‘.txt’ will be copied. This filter may be implemented in the evaluation step S602 of Subprocess 3.

In one aspect, the invention is a method carried out by a data processing system. In another aspect, the invention is computer program product embodied in computer usable non-transitory medium having a computer readable program code embedded therein for controlling a data processing apparatus to carry out the method. In another aspect, the invention is embodied in a data processing system.

It will be apparent to those skilled in the art that various modification and variations can be made in the file transfer method and related apparatus of the present invention without departing from the spirit or scope of the invention. Thus, it is intended that the present invention cover modifications and variations that come within the scope of the appended claims and their equivalents.

1. A file transfer method in a cloud system that includes a cloud server and at least one edge device implementing ThingWorx, the cloud server having a file repository, the edge device having a file system containing a plurality of nested variably named paths, the method comprising:
(a) receiving a file transfer request, the request specifying a transfer process name and a root path in the file system of the edge device that contains files to be transferred;
(b) iterating through all paths under the root path, identifying a plurality of child paths under the root path;
(c) identifying files to be transferred in all identified paths, based on a date range;
(d) transferring all files identified in step (c) from the edge device to the repository of the cloud server; and
(e) for any file transferred in step (d) that failed, storing path and file information of the file as an entry in a persistent failed file transfer infotable on the cloud server, the failed file transfer infotable being associated with the transfer process name.

2. The method of claim 1, wherein in step (a), the request further specifies a maximum retry count;
the method further comprising, after step (a) and before step (b):
(f) querying the failed file transfer infotable associated with the transfer process name to determine whether any entries exist;
(g) when any entries exist in the failed file transfer infotable, transferring files identified by the entries from the edge device to the repository of the cloud server; and
(h) updating the failed file transfer infotable, including:
for any file transferred in step (g) that completed successfully, removing the corresponding entry from the failed file transfer infotable; and
for any file transferred in step (g) that failed, incrementing a retry count for the corresponding entry by one, and when the retry count exceeds the maximum retry count, removing the corresponding entry from the failed file transfer infotable.

3. The method of claim 2, wherein the date range is based on a difference between a date of last successful file copied and a current date.

4. The method of claim 1, wherein the date range is based on an input of a of the file transfer request.

5. The method of claim 1, wherein in step (a), the request further specifies a list of path exclusions; and
wherein step (b) includes iterating through all paths under the root path using a control array, determining whether each path matches an entry in the list of path exclusions, and adding each path that does not match any entry in the list of path exclusions to a path infotable.

6. The method of claim 5, wherein step (c) includes:
iteratively evaluating paths in the path infotable to determine where any files exist in each path; and
when any files exist in a path and are within the date range, adding the files to a file infotable.

7. The method of claim 5, wherein in step (a), the request further specifies at least one file name mask; and
wherein step (c) includes:
iteratively evaluating paths in the path infotable to determine where any files exist in each path; and
when any files exist in a path, are within the date range, and have file names that match the file name mask, adding the files to a file infotable.

8. The method of claim 7, further comprising, after step (c) and before step (d), sorting the file infotable by a file last modified date.

9. The method of claim 1, further comprising logging a total run time, a path count, a file count, a most recent transfer date, and a transfer size of the file transfer.

10. The method of claim 1, wherein in step (a), the request further specifies a flag indicating an ad-hoc transfer process;
the method further comprising, after step (e): deleting all properties associated with the transfer process name.

11. A computer program product comprising a non-transitory computer readable storage medium having a computer readable program code embedded therein for controlling a cloud server in a cloud system, the cloud system including at least one edge device implementing ThingWorx, the cloud server having a file repository, the edge device having a file system containing a plurality of nested variably named paths, the computer readable program code configured to cause the cloud server to execute a process for file transfer, the process comprising:
(a) receiving a file transfer request, the request specifying a transfer process name and a root path in the file system of the edge device that contains files to be transferred;
(b) iterating through all paths under the root path, identifying a plurality of child paths under the root path;
(c) identifying files to be transferred in all identified paths, based on a date range;
(d) transferring all files identified in step (c) from the edge device to the repository of the cloud server; and
(e) for any file transferred in step (d) that failed, storing path and file information of the file as an entry in a persistent failed file transfer infotable on the cloud server, the failed file transfer infotable being associated with the transfer process name.

12. The computer program product of claim 11, wherein in step (a), the request further specifies a maximum retry count;
the process further comprising, after step (a) and before step (b):
(f) querying the failed file transfer infotable associated with the transfer process name to determine whether any entries exist;
(g) when any entries exist in the failed file transfer infotable, transferring files identified by the entries from the edge device to the repository of the cloud server; and
(h) updating the failed file transfer infotable, including:
for any file transferred in step (g) that completed successfully, removing the corresponding entry from the failed file transfer infotable; and
for any file transferred in step (g) that failed, incrementing a retry count for the corresponding entry by one, and when the retry count exceeds the maximum retry count, removing the corresponding entry from the failed file transfer infotable.

13. The computer program product of claim 12, wherein the date range is based on a difference between a date of last successful file copied and a current date.

14. The computer program product of claim 11, wherein the date range is based on an input of the file transfer request.

15. The computer program product of claim 11, wherein in step (a), the request further specifies a list of path exclusions; and
wherein step (b) includes iterating through all paths under the root path using a control array, determining whether each path matches an entry in the list of path exclusions, and adding each path that does not match any entry in the list of path exclusions to a path infotable.

16. The computer program product of claim 15, wherein step (c) includes:
iteratively evaluating paths in the path infotable to determine where any files exist in each path; and
when any files exist in a path and are within the date range, adding the files to a file infotable.

17. The computer program product of claim 15, wherein in step (a), the request further specifies at least one file name mask; and
wherein step (c) includes:
iteratively evaluating paths in the path infotable to determine where any files exist in each path; and
when any files exist in a path, are within the date range, and have file names that match the file name mask, adding the files to a file infotable.

18. The computer program product of claim 17, wherein the process further comprises, after step (c) and before step (d), sorting the file infotable by a file last modified date.

19. The computer program product of claim 11, wherein the process further comprises logging a total run time, a path count, a file count, a most recent transfer date, and a transfer size of the file transfer.

20. The computer program product of claim 11, wherein in step (a), the request further specifies a flag indicating an ad-hoc transfer process;
the method further comprising, after step (e): deleting all properties associated with the transfer process name.
